(19) United States
(12) Patent Application Publication
(10) Pub. No.: US 2005/0111370 A1
(43) Pub. Date: May 26, 2005

(54) Method and system for replacing lost or delayed data in sonet/sdh emulation protocols

(76) Inventor: Ron Cohen, Nes Ziona (IL)

Correspondence Address: Mark M Friedman;Bill Polkinghorn, Discovery Dispatch, 9003 Florin Way, Upper Marlboro, MD, 20772, US

(21) Appl. No.: 10/496,381

(22) PCT Filed: Dec. 3, 2002
(86) PCT No.: PCT/US02/38306

Related U.S. Application Data
(60) Provisional application No. 60/339,305, filed on Dec. 12, 2001.

(51) Int. Cl. H04L 1/00; H04J 1/16

(52) U.S. Cl. 370/242

(57) ABSTRACT

A method for replacing lost or delayed data in SONET/SDH emulation protocols for carrying signals over a packet network between a sender and a receiver. The method comprises receiving a plurality of packets, each said packet having packet parameters, detecting a missing packet and instead of the missing packet, playing out a replacement packet that includes replacement values chosen to minimize erroneous stuffing events. The replacement values are determined based on packet information tracked by the receiver (102), and optionally on statistics maintained by the receiver and on information tracked by the sender (100).

### FIELD AND BACKGROUND OF THE INVENTION

The present invention relates to SONET/SDH circuit emulation over packet (CEP) networks, and more specifically the compensation for lost data sent via emulation of SONET/SDH circuits over a packet infrastructure.

SONET/SDH is a transport technology that carries multiple lower rate signals within SONET/SDH containers. SONET/SDH carries the plesiochronous digital hierarchy (PDH) signals, including T1, E1, T3, E3 etc. These PDH signals are usually mapped asynchronously into the SONET/SDH containers, where “asynchronous” means that the clock driving the PDH signal may be different (not synchronized) to the SONET/SDH clock. To accommodate for different clocks, the SONET/SDH container can vary the number of PDH bits carried within each container segment. This technique is called bit stuffing. For example, a T1 carried asynchronously within the VT1.5 (TU-11) container may have 771, 772 or 773 bits per super-frame (a structure of 4 T1 frames). Usually the SONET/SDH container includes some bits that may or may not carry data, named “justification opportunity bits”, as well as carrying additional bits that indicate whether these bits carry data or not, named “justification control bits”.

The common prior art method of dealing with lost packets or with packets delayed beyond the jitter buffer boundary of a circuit emulation edge is illustrated in the block diagram of FIG. 1. In a system that includes a sender (“packetizer”) 100 and a CEP receiver (“de-packetizer”) 102, sender 100 packetizes SONET/SDH data into packets and sends them in a step 104 over a packet network to receiver 102. The receiver stores the received packets in a jitter buffer and plays them out on the SONET/SDH interface. Prior to play-out, the receiver determines if a packet is available for play-out or missing in a step 106. If the packet is available, the receiver plays out the received data onto the SONET/SDH interface in a step 108. If the jitter buffer of the receiver is empty, or the packet to be played out has not been received, the CEP de-packetizer invariably plays out an empty packet onto the SONET/SDH interface in place of the unavailable packet in a step 110. In a step 112, after the first empty packet play out, the receiver plays out the next packet (if received), or continues to play out empty packets. If the CEP de-packetizer encounters more than a configurable number of sequential empty packets, according to present practice the CEP de-packetizer must declare “loss of packet synchronization”, which is a term used to indicate that the circuit has become non operative.

Once a packet is lost, replaying an empty packet may indicate erroneous justification control bits, leading to a wrong interpretation of the justification opportunity bits, and therefore to the wrong number of PDH bits carried in this segment. If the end PDH service receives a wrong number of bits, the end circuits can lose frame synchronization. The time scale needed in order to recover from such loss of synchronization is relatively large, resulting in significant service disruption. The typical time scale for acquisition of frame synchronization is measured in milliseconds, while the payload carried within a packet is typically less than 0.5 millisecond of PDH data. For example, a single packet loss worth 0.25 millisecond may cause a service disruption of 5 milliseconds, which equals the loss of 20 packets.

In view of the prior art disadvantages mentioned above, there is a widely recognized need for, and it would be highly advantageous to have, a method for replacing lost or delayed data in SONET/SDH emulation protocols carrying PDH signals that prevents service disruption.

### SUMMARY OF THE INVENTION

The present invention is of a method and system for replacing lost or delayed data in SONET/SDH emulation protocol carrying PDH signals. Specifically, the present invention provides a method for replacing lost or delayed data by playing out data in a way that minimizes the effect on the service, while loss of packet synchronization is not yet declared. The method of the present invention works equally well with E1, T1, E3 or T3 PDH signals.

According to the present invention there is provided a method for replacing lost or delayed data in SONET/SDH emulation protocols for carrying plesiochronous digital hierarchy (PDH) signals over a packet network between a sender and a receiver, comprising the steps of: at the receiver: (a) receiving a plurality of packets, each the packet having packet parameters; (b) detecting a missing packet; and (c) instead of the missing packet, playing out a replacement packet that includes replacement values chosen to minimize erroneous stuffing events, the replacement values including replacement justification control bit values chosen based on the packet parameters.

According to the present invention there is provided a system for a system for replacing lost or delayed data in SONET/SDH emulation protocols used for carrying plesiochronous digital hierarchy (PDH) signals over a packet network between a sender and a receiver, comprising: (a) sender means for sending a plurality of packets to the receiver over the packet network, (b) receiver detecting means for detecting at least one missing packet among the plurality of packets; and (c) receiver packet replacement means for replacing the at least one missing packet.

### BRIEF DESCRIPTION OF THE DRAWINGS

The invention is herein described, by way of example only, with reference to the accompanying drawings, wherein:

FIG. 1 is a schematic block diagram of a prior art method of dealing with lost packets or packets delayed beyond the jitter buffer boundary of a circuit emulation receiver;

FIG. 2 is a schematic block diagram illustrating the main steps of the method of the present invention;

FIG. 3 describes common use bit asynchronous mapping of E1 and T1 signals into SONET/SDH VT1.5 (VC-11) and VT2 (VC-12) containers;

FIG. 4 shows a more detailed block diagram of the operations undertaken by the receiver in the case of E1 and T1 payloads;

FIG. 5 shows a block diagram of the steps of the present method for justification control bit replacement in SONET/SDH asynchronous T3 (DS-3) payloads.

FIG. 6 shows a schematic description of a system used for implementing the method described above in its different embodiments.

### DESCRIPTION OF THE PREFERRED EMBODIMENTS

The present invention is of a method and system for replacing lost or delayed data in SONET/SDH emulation protocol carrying PDH signals. Specifically, the present invention provides a method for replacing lost or delayed data by playing out data in a way that minimizes the effect on the service, while loss of packet synchronization is not yet declared.

The principles and operation of a method and system for replacing lost or delayed data in SONET/SDH emulation protocols according to the present invention may be better understood with reference to the drawings and the accompanying description.

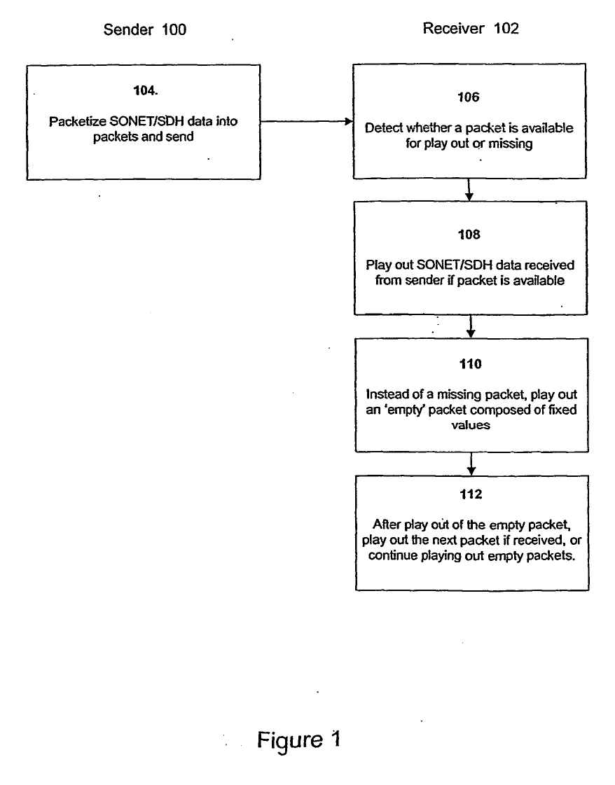

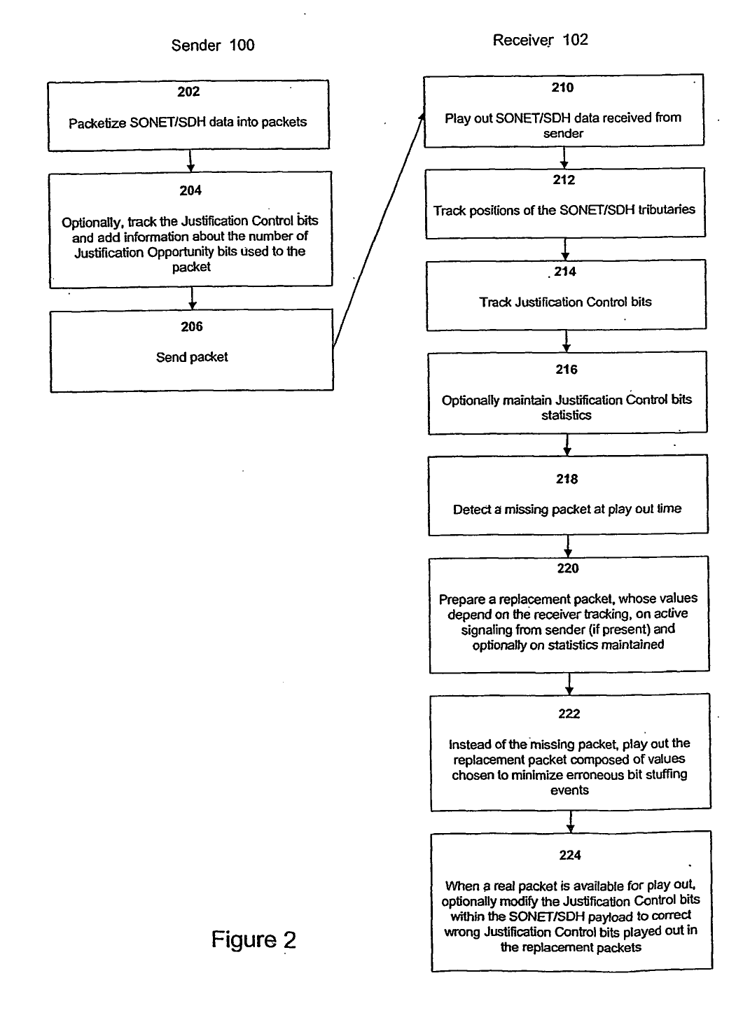

FIG. 2 illustrates in a block diagram the main steps of the method. In a general system having the same sender 100 and receiver 102 as in FIG. 1, the sender packetizes SONET/SDH data into packets in a step 202. Optionally, in a step 204, the sender tracks justification control bits of the SONET/SDH containers carrying PDH data within each packet, and adds information about the number of bit stuffing events that occurred within the information carried in the packet. The sender then sends the packet over the packet network to the receiver in a step 206. The receiver receives the packet and plays it out in a step 210. The receiver continuously tracks the positions of the SONET/SDH tributaries in a step 212, and at the same time tracks the justification control bits in a step 214. Optionally, the receiver maintains statistics of the justification control bits in a step 216. The receiver detects a missing packet in a step 218. The receiver now effects a key and novel step 222 in the method of the present invention: contrary to prior art play-out of an empty packet instead of the missing one, in the present invention the receiver, plays out a replacement packet composed of “replacement” values that include replacement justification control bit values chosen to minimize erroneous bit-stuffing events. This is explained in more detailed below. The replacement packet values, also discussed in detail below, are prepared in step a 220, and depend on the receiver tracking of SONET/SDH tributaries and justification control bits played out in previous packets (steps 212 and 214), and optionally on the statistics maintained by the receiver in step 216. Finally, in a step 224, when the receiver detects from sequence numbering a real (non-missing) packet for play-out, it optionally modifies the justification control bits within the SONET/SDH payload to correct the wrong justification control bits played out in the replacement packets.

T1 (DS-1)/E1 Payload Mapping

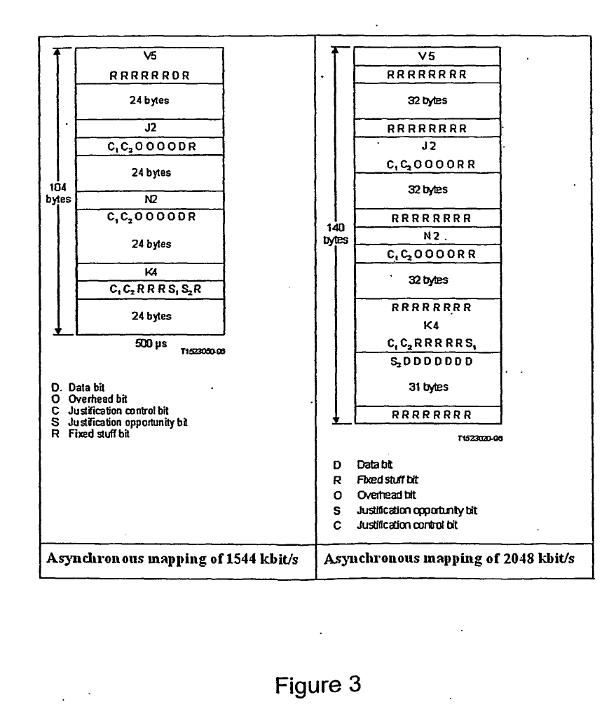

In order to better understand the choice of bit values for, and the play-out of the replacement packets according to the present invention, reference is first made to T1 and E1 asynchronous mappings to SONET/SDH. FIG. 3 describes common use bit asynchronous mapping of E1 and T1 signals into SONET/SDH VT1.5 (VC-11) and VT2 (VC-12) containers. All T1/E1 bits, including framing bits, are treated as payload. The asynchronous mapping allows a single bit-stuffing event (either positive or negative) each super-frame. The justification bits are used in the same fashion in the two encapsulations. Two sets of three justification control bits are used to control the two justification opportunity bits S₁ and S₂, respectively. (C₁C₁C₁)=(000) indicates that S₁ is a data bit while (C₁C₁C₁)=(111) indicates that S₁ is a justification bit. C₂ controls S₂ in the same way. The justification control bits are organized in three, first, second and third (C1, C2) pairs within each super-frame. Majority vote should be used to make the justification decision in the de-synchronizer for protection against single bit errors in the C bits. The value contained in S₁ and S₂ when they are justification bits is not defined. The receiver is required to ignore the value contained in these bits whenever they are used as justification bits.

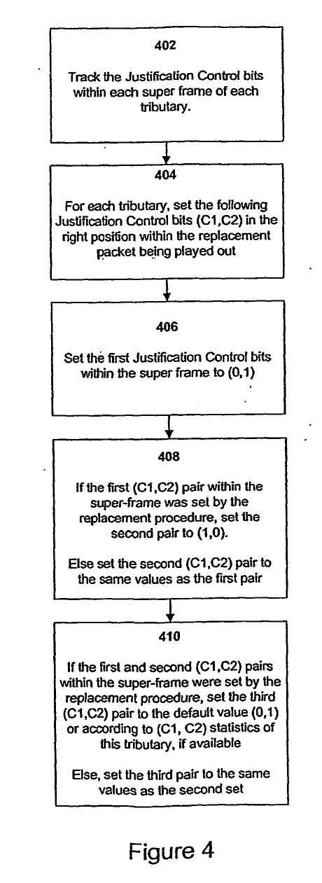

Returning now to the method of the present invention, FIG. 4 shows a more detailed block diagram of the operations undertaken by the receiver in the case of E1 and T1 payloads. In a step 402 (identical with step 214 of FIG. 2) the justification bits (C1 and C2) of each super-frame are tracked for each tributary. Next, in a step 404, for each tributary, replacement justification control bits (C1, C2) are set in the right position within the replacement packet being played out. The setting is done according to the following: in a step 406, the receiver knows from tracking step 402 if one or more of the justification control bit pairs is missing, or if it arrives in a tracked real packet belonging to a tributary super-frame. The receiver then effects replacement as follows: if the first (C1, C2) pair did not arrive in a tracked real packet, the first replacement (C1, C2) values need to be set in the replacement packet, and are set to (0,1). We refer to such a setting as a “setting by the replacement procedure” of the present invention. If the first replacement (C1, C2) pair was thus set by the replacement procedure in step 406, and the second replacement (C1, C2) pair needs to be set as well by the replacement procedure (the need known from the tracking), then in a step 408 the second replacement pair (C1, C2) is set to (1,0). Else, if the first replacement (C1, C2) pair was played out due to a packet received from the sender (i.e. set to values of a first pair (C1, C2) received in a real packet), the second replacement pair is set to the same value as that first pair. Finally, in a step 410, if the third pair replacement (C1, C2) needs to be set by the replacement procedure, it is set according to the following: if the first and second replacement pairs were set by the replacement procedure, (i.e. (0,1) and (1,0)) then the third replacement pair is set to the default value (0,1) or according to the (C1, C2) statistics of this tributary, if available from step 216. Else (i.e. if the first pair may have been replaced, but the second pair has not been), the third replacement (C1, C2) values are set to the same values as the second pair, using values tracked in step 402.

This method works as long as no complete super-frame has been lost. To guard against missed justification events across a super-frame, signaling should be added by the sender as described in the general method in FIG. 2. This approach is described in more detail in the T3 replacement procedure embodiment in FIG. 3.

T3 (DS-3) /E3 Payload Mapping

Reference is now made to T3 SONET/SDH asynchronous mappings, which are well known in the art. The rate of DS-3 is 44736 kb/sec. The STS-1 (VC-3) carrying the T3 consists of nine sub-frames every 125 μs. Each sub-frame consists of one byte of STS-1 (VC-3) payload overhead bytes, 621 data bits, a set of five justification control bits, one justification opportunity bit and two overhead communication channel bits. The remaining bits are Fixed Stuff (R) bits. Each sub-frame carries 44736*0.125/9=621 ⅓ bits. Therefore the justification control bits allow positive and negative justification.

The set of five justification control bits is used to control the justification opportunity (S) bit. (CCCCC)=(00000) indicates that the S bit is a data bit, whereas (CCCCC)=(1111) indicates that the S bit is a justification bit. Majority vote should be used to make the justification decision in the de-synchronizer for protection against single and double bit errors in the C bits. The value contained in the S bit when used as a justification bit is not defined. The receiver is required to ignore the value contained in this bit whenever it is used as a justification bit. The DS-3 is carried in SONET/SDH format, and therefore multiple justification events may occur in a single lost packet payload. In order to have a good guess of the number of justification events when lost data is played out, statistics on number of justification events per N SONET frames is maintained. In order to make sure the right number of events was played out, sender signaling of the number of justification events is needed.

Similarly, in well known prior art E3 mapping, two sets of five justification control bits C₁ and C₂ are used to control the two justification opportunity bits S₁ and S₂, respectively. (C₁C₁C₁C₁C₁)=(00000) indicates that S₁ is a data bit while (C₁C₁C₁C₁C₁)=(11111) indicates that S₁ is a justification bit. The C₂ bit controls S₂ in the same way. Majority vote should be used to make the justification decision in the de-synchronizer for protection against single and double bit errors in the C bits. The value contained in S₁ and S₂ when they are justification bits is not defined. The receiver is required to ignore the value contained in these bits whenever they are used as justification bits.

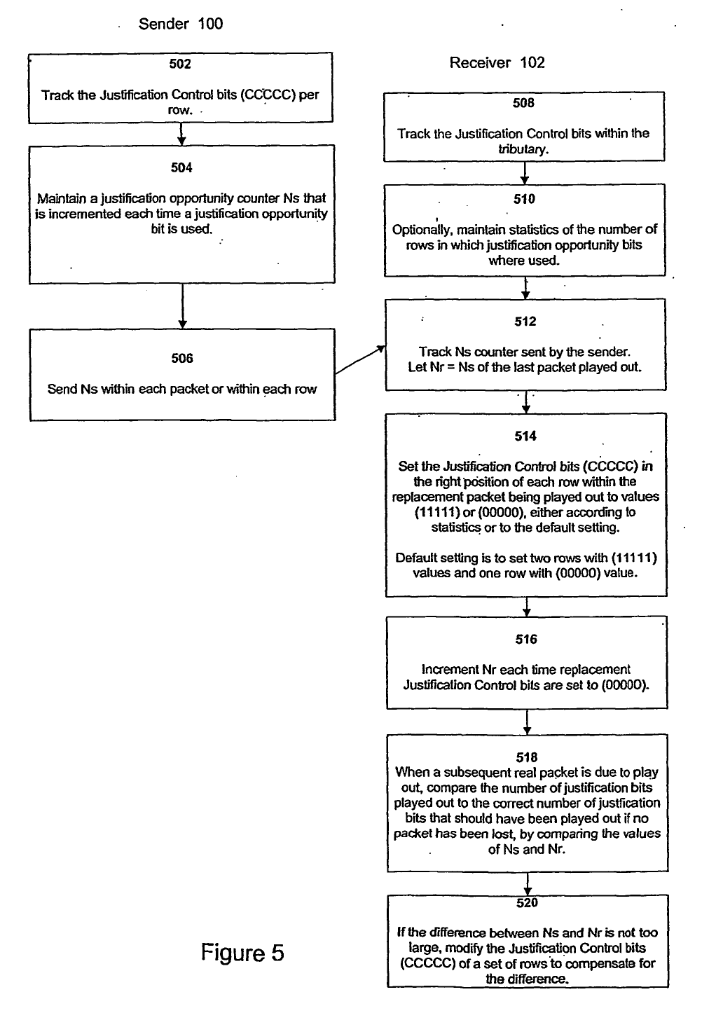

FIG. 5 shows a block diagram of the steps of the present method for justification control bit replacement in SONET/SDH asynchronous T3 payload. The method described below is equally useful for E3 mappings, the only differences between T3 and E3 being in the number of justification control/opportunity bits, etc. We will thus refer to T3, with the understanding that the method covers E3 and other possible SONET/SDH payloads.

Using for simplicity the same sender 100, the sender tracks the justification control bits (CCCCC) per row in a step 502. In a step 504, the sender maintains a justification opportunity counter Nₛ that is incremented each time a justification opportunity bit is used. Nₛ reflects the number of opportunity bits used until the payload carried in the next packet or row. Then, in a step 506, the sender sends counter Nₛ within each packet or within each row. At the other edge, receiver 102 tracks the justification control bits within the tributary in a step 508, and, optionally, maintains statistics of the number of rows in which justification opportunity bits were used in a step 510. The receiver receives counter Nₛ from the sender and tracks the number of used justification opportunity bits in a step 512. The receiver then sets a receiver counter Nᵣ=Nₛ of the last real packet played out. In a next step 514, when a replacement packet needs to be played out, the receiver sets the justification control bits (CCCCC) in the right position of each row to values (11111) or (00000), either according to statistics acquired in step 510 or according to the default setting. The default setting is to set two rows with (11111) values, and one row with (00000) values. Each time justification control bits (CCCCC) are set to (00000) within the replacement packet, the receiver increases Nᵣ incrementally in a step 516. When a subsequent real packet is due to play out, the receiver, in a step 518, compares the values of Nₛ and Nᵣ. That is, the receiver compares the number of justification opportunity bits used in the replacement packet with the correct number of justification opportunity bits that should have been used had no packet been lost. If the difference between Nₛ and Nᵣ is not too large (e.g. can be compensated by changing the justification control bits of a single real packet), the receiver modifies the justification control bits (CCCCC) of a set of rows to compensate for the difference in a step 520.

The T3/E3 replacement procedure may also be implemented without the sender adding information. In this mode, the receiver tracks the justification control bits and chooses the replacement values such that the justification opportunity bits used match either the default values or the statistics maintained. By adding the signaling from the sender claim, we add the stage in which the ‘real’ packet justification bits are modified to correct (if needed) the justification bits that were added in the replacement packet.

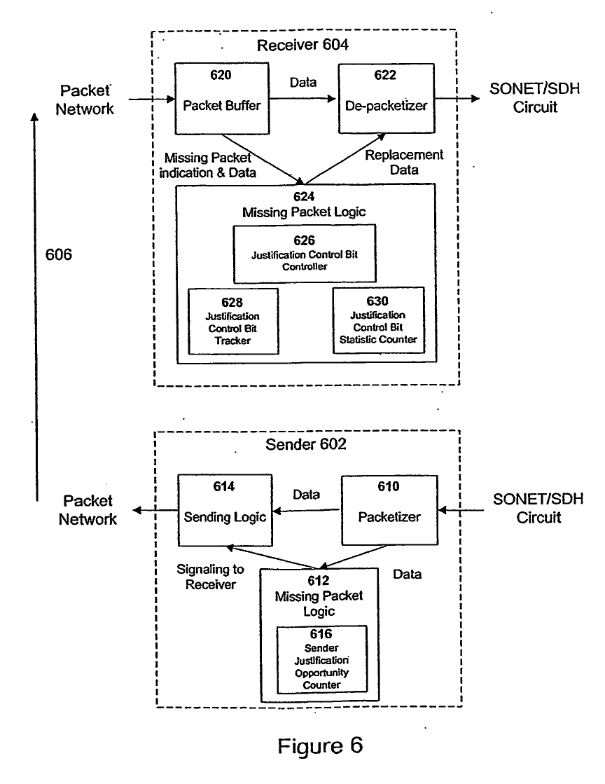

FIG. 6 shows a schematic description of a system used for implementing the method described above in its different embodiments. The system includes a sender 602 connected to a receiver 604 through a packet network 606. Sender 602 includes sender means comprised of a packetizer 610 that receives SONET/SDH data from a SONET/SDH circuit and transforms it into a packet, an optional missing packet logic 612 that adds signaling derived through a justification opportunity counter 616, and a sending logic 614. Sending logic 614 combines packet data received from packetizer 610 and the signals from sender missing packet logic 612, and sends the combined packet information to receiver 604 over packet network 606. Receiver 604 includes receiver means comprised of a packet buffer 620 through which it receives the packet information sent by the sender, and a de-packetizer 622 that takes the packet information from buffer 620 and plays it out on a SONET/SDH circuit. The receiver also includes receiver packet replacement means in the form of a receiver missing packet logic 624 that provides a replacement packet if a packet is missing. Packet buffer 620 provides the necessary indication of a missing packet (and the sender signaling, if exists) to missing packet logic 622. The novelty of the system of the present invention is derived from three additional elements included in receiver missing packet logic 622, which do not normally exist in prior art systems. These are a justification control bit controller 628, a justification control bit tracker 630, and a justification control bit counter 632. Justification control bit controller 628 is responsible for setting the justification control bits in the replacement packets according to the method described above, and optionally to correct the justification control bits in real packets according to sender signaling. In order to perform these tasks, justification control bit controller 628 uses bit information provided by justification control bit tracker 630, which tracks justification control bits, and optionally, from justification control bit counter 632, which counts these bits. Also novel are the sender missing packet logic 612 and its sub-element, the sender justification opportunity bit counter 616. The system of FIG. 6 can be advantageously implemented in various software and/or hardware configurations.

In summary—the method of the present invention has a number of clear advantages over other prior art methods, either used or planned, in that:
The present method is good for emulation of a SONET/SDH tributary carrying a single PDH payload up to emulation of an SONET/SDH container carrying multiple PDH tributaries.
The present method can be implemented ‘on the fly’ and does not require adding additional delay in the de-packetization process
The present method does not assume subsequent packets have already arrived prior to play out time.
The present method is simple to implement, and relies on existing and proposed standards.

While the invention has been described with respect to a limited number of embodiments, it will be appreciated that many variations, modifications and other applications of the invention may be made.

1. A method for replacing lost or delayed data in SONET/SDH emulation protocols for carrying plesiochronous digital hierarchy (PDH) signals over a packet network between a sender and a receiver, comprising the steps of: at the receiver:
a. receiving a plurality of packets, each said packet having packet parameters;
b. detecting a missing packet; and
c. instead of said missing packet, playing out a replacement packet that includes replacement values chosen to minimize erroneous stuffing events, said replacement values including replacement justification control bit values chosen based on said packet parameters.

2. The method of claim 1, wherein said packet parameters further include positions of SONET/SDH tributaries.

3. The method of claim 1, wherein, optionally, the receiver maintains statistics of justification control bits, and uses said statistics in said step of playing out a replacement packet, whereby the use of said statistics enhances said choice of said replacement justification control bit values.

4. The method of claim 1, wherein said packet parameters include information about justification control bits tracked by the sender.

5. The method of claim 1, further comprising the steps of;
d. tracking, justification control bits sent by the sender; and,
e. for a play-out of a real packet, modifying said justification control bits to correct wrong justification control bits played out in at least one replacement packet preceding said real packet.

6. The method of claim 1, implemented for T1 and E1 PDH signals mapped asynchronously into a SONET VT1.5/VT2 or into a SDH VC-11/VC-12 tributary having super-frames, wherein said choice of said replacement justification control bit values further includes:
i. tracking said justification control bits within each said super-frame of each said tributary;
ii. if needed, for each said tributary, setting a first pair (C1, C2) of replacement justification control bits values to a first pair of values;
iii. depending on said first pair of values, setting a second pair (C1, C2) of replacement justification control bits to a second pair of values; and
iv. depending on said first and second pairs of values, setting a third pair (C1, C2) of replacement justification control bits to a third pair of values.

7. The method of claim 6, where said choice of said replacement justification control bit values further includes:
v. if said first pair of justification control bits needs to be set by a replacement procedure in the replacement packet, setting said first pair of values to (0,1).
vi. if said first (C1, C2) pair was set by said replacement procedure, and if said second pair of replacement values needs to be set as well, setting said second pair (C1, C2) to (1,0); else, if said first (C1, C2) pair was played out due to a packet received from the sender, setting said second pair is set to the same pair of values as said first pair.
vii. if said third pair (C1, C2) needs to be set within a replacement packet, and if said first and said second pairs were set by said replacement procedure, to (0,1) and (1,0) respectively, setting said third pair to a pair of values selected from the group consisting from a default pair of values (0,1) and a pair of values chosen based on statistics of previous justification control bits of said tributary.

8. The method of claim 1 implemented for SONET/SDH E3/T3 asynchronous mapping.

9. The method of claim 8, wherein said replacement justification control bits are set to default values maintaining a nominal clock difference between T3/E3 and the SONET/SDH container.

10. The method of claim 1, implemented for T3/E3 PDH signals mapped asynchronously into a SONET STS-1 or SDH VC-3 tributary having sub-frames arranged in rows, wherein said determination of said replacement justification control bit values includes the substeps of: at said sender:
i. tracking said justification control bits per each said row,
ii. maintaining a sender counter Ns that is incremented every time a justification opportunity bit is used in a said row, and
iii. sending said sender counter Ns within each said packet or said row to said receiver; and: at said receiver:
iv. tracking said justification control bits received from said sender,
v. optionally, maintaining statistics of rows having said justification opportunity bits,
vi. tracking said Nₛ, and
vii. based on said tracking of said justification control bits sent by the sender and on said Nₛ, deciding whether said replacement values used are correct, and if not, modifying said justification control bits in a next packet to compensate accordingly.

14. A system for replacing lost or delayed data in SONET/SDH emulation protocols for carrying plesiochronous digital hierarchy (PDH) signals over a packet network between a sender and a receiver, comprising
a. sender means for sending a plurality of packets to the receiver over the packet network, said plurality of packets including justification control bits;
b. receiver detecting means for detecting at least one missing packet; and
c. receiver packet replacement means for replacing said at least one missing packet with a replacement packet, said receiver packet replacement means further including:
i. a justification control bit tracker for tracking said justification control bits and providing relevant bit tracking information,
ii. a justification control bit counter for optionally counting said justification control bits, and providing relevant bit counting information, and
iii. a justification control bit controller that uses said bit-tracking information, and, optionally, said bit counting information, to set replacement packet justification control bit values in said replacement packet based on said tracking information and optional counting information.

15. The system of claim 14, wherein said sender means include a sender replacement logic and a sender justification opportunity counter, and wherein said receiver packet replacement includes correction means for optionally modifying justification control bits of at least one packet received from the sender, said correction based on information sent by said sender replacement logic and said sender justification opportunity counter.
